(19) United States
(12) Patent Application Publication
(10) Pub. No.: US 2017/0364038 A1
(43) Pub. Date: Dec. 21, 2017

(54) Kinetic Powered Smartwatch

(71) Applicant: Yehuda Fulda, Seminole, FL (US)

(72) Inventor: Yehuda Fulda, Seminole, FL (US)

(21) Appl. No.: 15/624,585

(22) Filed: Jun. 15, 2017

Related U.S. Application Data
(60) Provisional application No. 62/350,444, filed on Jun. 15, 2016.

(51) Int. Cl. G04G 19/00; H02K 7/116; H02K 1/27; F03G 5/06; H02K 1/14; F03G 7/08; H02K 7/18; H02K 7/06

(52) U.S. Cl. CPC G04G 19/00; H02K 7/1853; H02K 7/116; H02K 7/061; F03G 5/06; H02K 1/14; F03G 7/08; H02K 1/27

(57) ABSTRACT

A kinetically-powered wrist-worn electronic device is apparatus that includes a portable computing device, a wrist strap, a weight, and a generator. The portable computing device runs an operating system responsible for managing and distributes computing resources to various application software on the present invention. A wireless communication module accesses a wireless local area network (WLAN) or a wide area network (WAN) and enables the portable computing device to communicate with external computing devices. The wrist strap secures the portable computing device onto the wrist of the wearer. The weight uses a swinging mass which is designed to oscillate whenever the wearer moves his or her wrist. The generator harnesses and transforms the kinetic energy generated by the oscillating weight into usable electrical energy to power the portable computing device. The electrical energy is stored in a portable power which transfers the electrical energy to the portable computing device.

The current application claims a priority to the U.S. Provisional Patent application Ser. No. 62/350,444 filed on Jun. 15, 2016.

### FIELD OF THE INVENTION

The present invention generally relates to a kinetically-powered wrist-worn electronic device. More specifically, the kinetically-powered wrist-worn electronic device utilizes a generator mounted with a weight, which, when perturbed, generates electrical energy that is harnessed inside a portable power supply and used to power a portable computing device.

### BACKGROUND OF THE INVENTION

Lithium-ion batteries are the current state of the art in battery technology. Lithium-ion batteries provide the highest energy density out of any commercially available battery chemistry. However, even with the use of batteries with high energy densities, modern electronic devices have a hard time lasting for a whole day under heavy use. Further, storing large amount of electrical energy in a confined space is inherently dangerous. Lithium-ion batteries and similar high-density batteries are susceptible to combust when the outer housing is damaged.

Smartwatches are a growing trend because of their convenience and portability. However, smartwatches have very small interior compartments incapable of containing anything other than a very small battery. Current rechargeable battery technology, such as lithium-ion batteries, typically cannot supply enough power to a smartwatch for an entire day of usage. These devices need a reliable source of power to function for an entire day.

Conventional wrist watches use a variety of self-charging mechanisms to replenish power to the battery. This allows most wrist watches to operate for months or years without having to have the battery replaced or recharged. One such mechanism converts the kinetic energy generated by the natural movement of the wearer to electrical energy which is then used to recharge a battery.

The present invention provides a self-recharging power source, which can be used to augment or replace the rechargeable battery used in conventional electronic device. The present invention uses a person's natural motion to generate kinetic energy which is then transformed into electrical energy with the use of a generator. A suspended weight oscillates when the wearer moves his or her wrist. The suspended weight is connected to a generator which transforms the kinetic energy of the oscillating suspended weight to electrical energy. The electrical energy is then stored in a battery and distributed to a portable computing device found in a smartwatch.

### BRIEF DESCRIPTION OF THE DRAWINGS

FIG. 1 shows a perspective view of the weight, the generator, the portable power supply, and the power-management integrated circuit engaged together in the preferred manner.

FIG. 2 shows an exploded view of the generator, the portable power supply, and the power-management integrated circuit.

FIG. 3 is a perspective view of the preferred embodiment of the kinetically-powered wrist-worn electronic device.

FIG. 4 shows the weight, the generator and the portable computing device engaged inside the housing according to a preferred embodiment of the present invention.

FIG. 5 is a detail view of the portable computing device positioned within the housing.

FIG. 6 is a diagram showing the electronic connections of the present invention.

FIG. 7 is a diagram showing the electrical connection of the present invention.

### DETAILED DESCRIPTION OF THE INVENTION

All illustrations of the drawings are for the purpose of describing selected versions of the present invention and are not intended to limit the scope of the present invention.

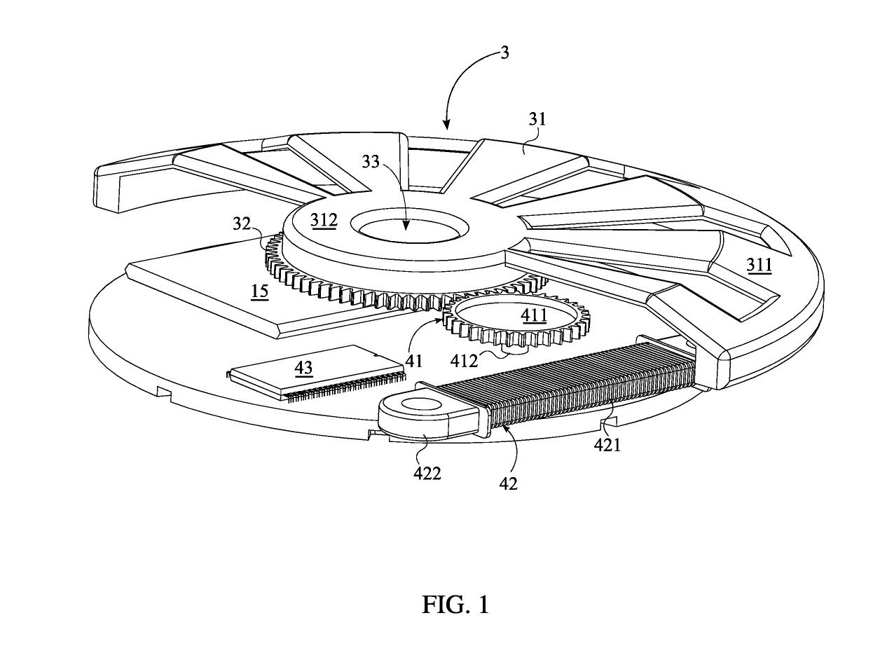

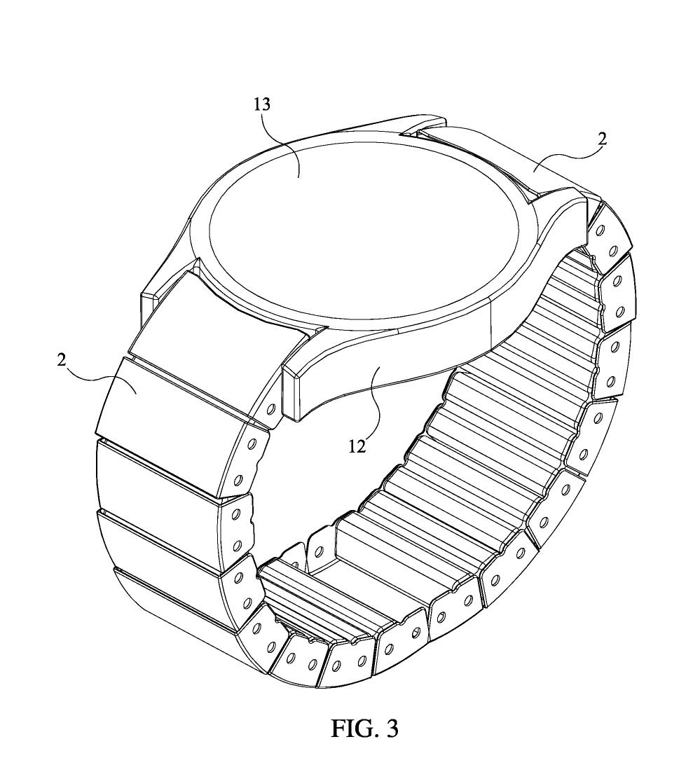

The present invention is a kinetically powered wrist-worn device. The kinetically powered wrist-worn device converts kinetic energy created by the wearer's motion to electrical energy, which can be used to power a portable computing device. In reference to FIG. 1 and FIG. 3, the preferred embodiment of the present invention comprises a portable computing device 1, a wrist strap 2, a weight 3, and a generator 4. The wrist strap 2 is used to retain the portable computing device 1, the weight 3, and the generator 4 on the wearer's wrist. Mounting the present invention on the wearer's wrist maximizes the kinetic energy that can be harvested. This is because the wrists are one or the few areas of human anatomy that is in frequent motion. In alternate embodiments however, the present invention can be worn anywhere on the wearer's body such as the arms, the waist, or the head. The wrist strap 2 is a band that is preferably made of polymeric or fabric materials, that wrap around the wrist of the wearer. A male end and a female end of the wrist strap 2 may be fashioned with selectively fastening mechanism. For example, a buckle mounted to the male end may form a selective coupling with a plurality of holes positioned longitudinally along the female end. Alternately, the fastening mechanism may also comprise snap locks, magnetic fasteners, hook-and-loop fasteners, and/or similar fastening mechanisms. The portable computing device 1 further comprises a housing 12, a touchscreen 13, a microprocessor 14, and a portable power supply 15. The portable computing device 1 runs on an operating system that allows various applications layered. The generator 4 comprises a rotor 41 and a stator 42. The generator 4 harvests the kinetic energy generated when the wearer is in motion and transforms the kinetic energy into electrical energy. The generator 4 then supplies this electrical energy to the portable power supply 15, as the power level is being drained.

As can be seen in FIG. 3, the wrist strap 2 is externally mounted onto the housing 12. The housing 12 protects the electrically operated components from environmental elements such as moisture that can interfere with the electrical circuitry. The housing 12 may be waterproof and dustproof allowing the wearer to use the present invention in wet or dry environments. The touchscreen 13 is mounted into the housing 12. The touchscreen 13 is positioned on an easily observable area on the outer surface of the housing 12. A graphical user interface (GUI) displayed on the touchscreen 13 allows the wearer to interact with the system software of the present invention. The housing 12 also contains a microprocessor 14 that is electrically connected to the touchscreen 13. The microprocessor 14 processes touch inputs generated by the user and outputs information on the touchscreen 13. In addition to the touchscreen 13, the microprocessor 14 may be in electrical connection with a plurality of output devices. The plurality of output devices includes, but is not limited to, speakers, printers, cameras, modems, discs, secure digital (SD) cards, and the like.

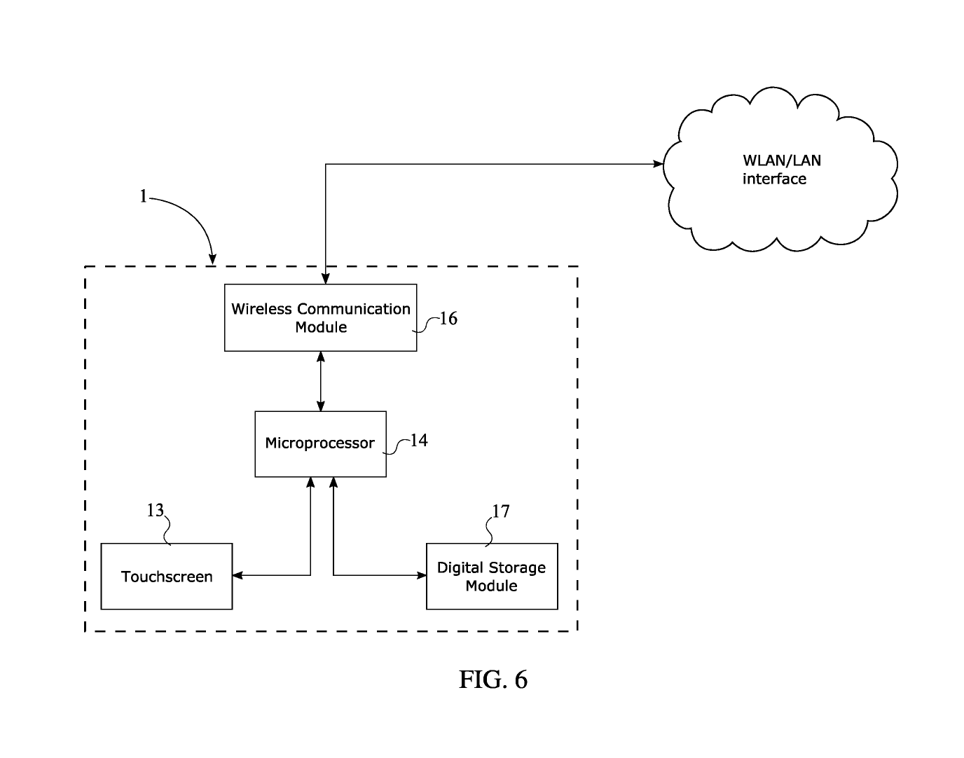

As can be seen in FIG. 1 and FIG. 6, the weight 3 is oscillatably mounted inside the housing 12. The weight 3 mounts to the housing 12 in a manner which allows the weight 3 to move independently inside the housing 12. This motion creates the kinetic energy used to drive the generator 4. The weight 3 is also torsionally connected to the rotor 41. The torsional connection transfers kinetic energy generated by the oscillating weight 3 to the rotor 41. This causes the rotor 41 to rotate and create a magnetic field which generates an electrical current in the stator 42. The stator 42 is electrically connected to the portable power supply 15 which allows an electric current to travel between the stator 42 and the portable power supply 15. The portable power supply 15 is also electrically connected to the microprocessor 14 and the touchscreen 13. This enables the portable power supply 15 to independently supply energy to the touchscreen 13 and the microprocessor 14. In alternate embodiments, a power management controller in electrical connection with the portable power supply 15 supplies energy to various electrically operated components. The power management controller is used to modulate the power supplied to a particular component, without effecting the power available to other components.

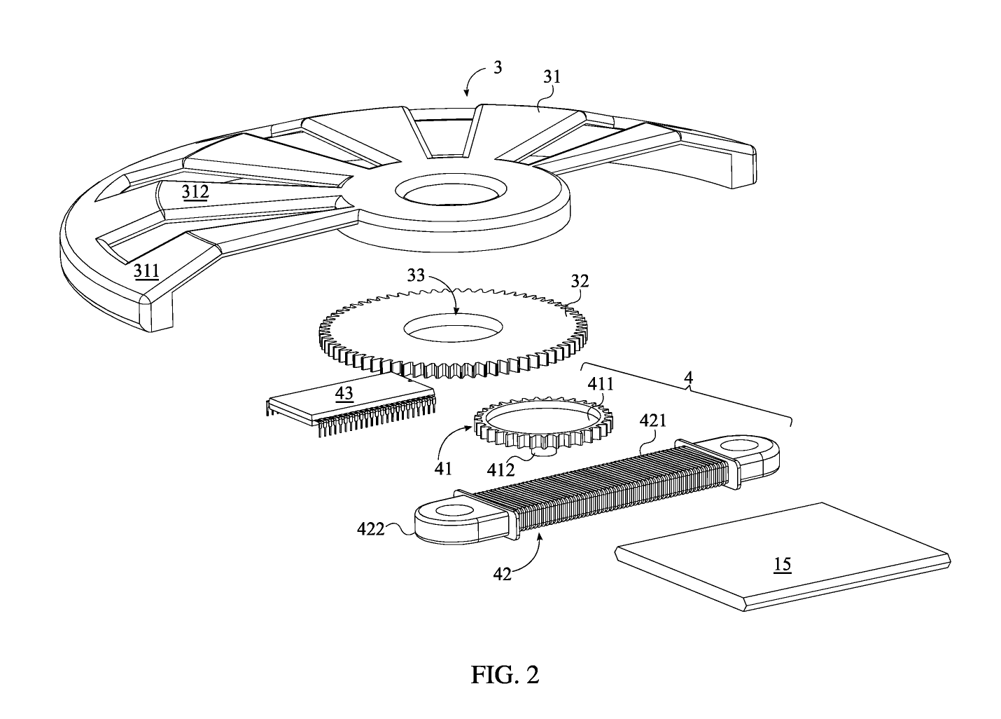

Referring now to FIG. 2, the preferred embodiment of the weight 3 further comprises a swinging mass 31 and a sun gear 32. The swinging mass 31 is swivelably mounted within the housing 12 about a rotation axis 33. The rotation axis 33 is rotatably mounted to a lateral wall of the housing 12. Mounting the swinging mass 31 on the rotation axis 33 frees the swinging mass 31 to move in relation to the housing 12. Thus, the swinging mass 31 may rotate even when the housing 12 is rotationally static. In the mounted position, the center of mass of the swinging mass 31 is offset from the rotation axis 33. Any movement in horizontal direction, causes the swinging mass 31 to start swinging about the rotation axis 33 which generates kinetic energy. The sun gear 32 is engaged to the rotor which allows the sun gear 32 to transfer kinetic energy to the rotor 41 in the form of torque. The sun gear 32 is coaxially positioned on with the rotation axis 33. The sun gear 32 is also torsionally connected to the swinging mass 31. Rotational motion generated by the swinging mass 31 is transferred to the sun gear 32 via the torsional connection. Alternately, the sun gear 32 may be integrated to the swinging mass 31 which causes both the swinging mass 31 and the sun gear 32 to move together. In such a case, the sun gear 32 and the swinging mass 31 are placed adjacent to each other along the rotation axis 33.

Again, referring to FIG. 1, in another feature of the swinging mass 31, the swinging mass 31 comprises a peripheral portion 311 and central portion 312. The peripheral portion 311 and a central portion 312 are positioned offset from each other along the rotation axis 33. A sloping lateral surface offsets the peripheral portion 311 from the central portion 312. This also creates a concave side opposite the central portion 312 and the peripheral portion 311 which creates a space that can be used to house other components of the present invention. In the preferred embodiment of the present invention, the swinging mass 31 has a semicircular profile. The semicircular profile ensures that the center of mass remains offset from the rotation axis 33. This condition is crucial to enable the swinging mass 31 to successfully swing about the rotation axis 33. The shape of swinging mass 31 must be optimized to maximize the moment of inertia, which increases the resultant torque available to the rotation axis 33. In order to do so, the center of mass must be placed at a radially distant position from the rotation axis 33. Further, it is preferable to concentrate the mass density around the outer rim of the swinging mass 31, which displaces the center of mass to the farthest point from the rotation axis 33. Even the smallest disturbance in the horizontal direction, will cause the swinging mass 31 to swing rapidly and generate a large amount of kinetic energy. In alternate embodiments, the swinging mass 31 can be rectangular, or generally polygonal in shape.

Again, referring to FIG. 2, the rotor 41 of the present invention further comprises a planet gear 411 and a magnet 412. The stator 42 comprises a plurality of induction coils 421. The planet gear 411 is engaged to the sun gear 32 of the weight 3. The planet gear 411 is fashioned with a plurality of teeth that interlocks with a matching plurality of teeth disposed on the sun gear 32. The planet gear 411 is tangentially positioned to the sun gear 32, allowing the sun gear 32 to transfer rotational motion, or torque, to the rotor 41. Since the planet gear 411 is substantially smaller than the sun gear 32, the planet gear 411 spins significantly faster than the sun gear 32. This relation causes the planet gear 411 to amplify the high-torque, low-power input provided by the sun gear 32 into a high-power, low-torque output. The amplified output is used to drive the magnet 412, which is coaxially mounted to the planet gear 411. This specific gearing arrangement allows the magnet 412 to spin several times for each swing of the swinging mass 31. Using the amplified output, the magnet 412 is able to produce a powerful magnetic field.

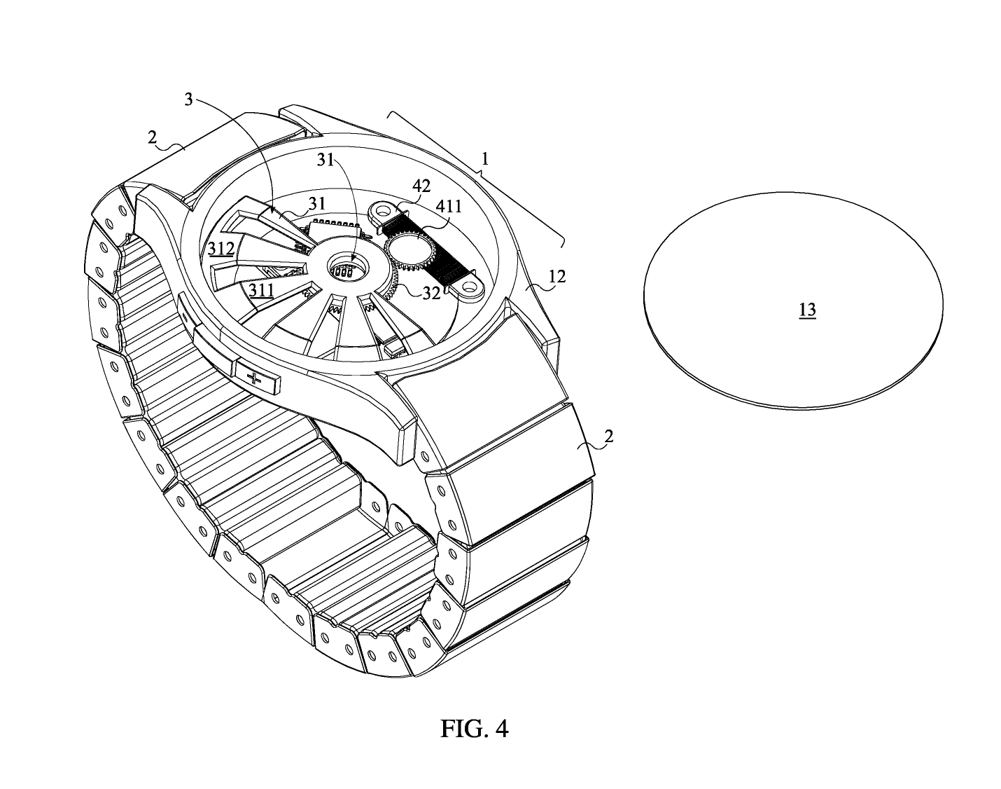

Referring now to FIG. 4, the magnet 412 is preferably a dipole magnet with the positive and the negative portions positioned opposite each other. The plurality of induction coils 421 is mounted within the housing 12. The plurality of induction coils 421 is made of highly conductive metallic materials. The plurality of induction coils 421 is wound around a core made of high-strength rigid material. For example, in one possible embodiment, the plurality of induction coils 421 is constructed out of insulated copper wires wound around an iron core. This allows the plurality of induction coils 421 to be in electromagnetic communication with the magnet 412. The plurality of induction coils 421 must be placed in close proximity to the magnet 412 for effective magnetic induction to occur. Spinning the magnet 412 at a high speed creates a varying magnetic field which causes magnetic induction within the plurality of induction coils 421. In the presence of varying magnetic field, a small electrical current is generated in the plurality of induction coils 421. The plurality of induction coils 421 is electrically connected to the portable power supply 15. The electrical connection facilitates transference of the electrical current from the plurality of induction coils 421 to the portable power supply 15. The electrical current is used to fully or partially recharge the portable power supply 15. In one possible embodiment, the generator 4 may produce enough power to keep the portable power supply 15 at full power for the usable life of the present invention. In another possible embodiment of the present invention, the generator 4 may act as a complementary power source which prolongs the life of the portable power supply 15 but is not meant to power the present invention in perpetuity. In such a case, the portable computing device 1 is provided with a Universal Serial Bus (USB) port which can be used to supply electrical energy to the portable power supply 15. The preferred embodiment of the stator 42 comprises a flat core 422. The plurality of induction coils 421 is wrapped around the flat core 422 in an elliptical fashion. This allows the stator 42 to occupy a smaller space within the housing 12.

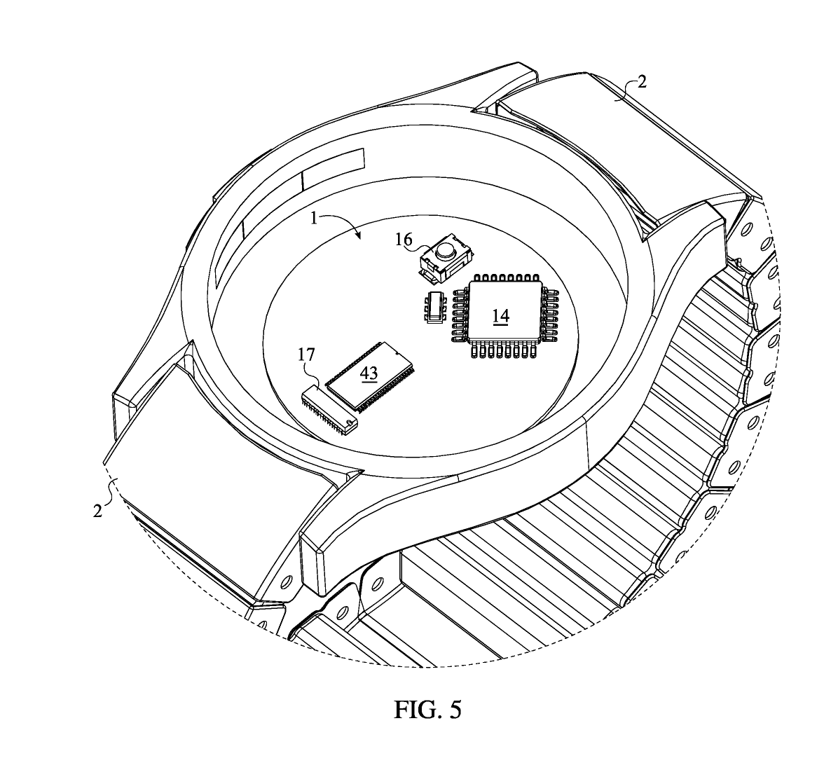

In reference to FIG. 5, the portable computing device 1 of the present invention may further comprise a power-management integrated circuit 43. The power-management integrated circuit 43 is electrically connected to the generator 4. The power-management integrated circuit 43 regulates the electrical energy coming from the generator 4 and sends the regulated electrical energy to the portable power supply 15. During the regulation process, the periodic supply of power from the generator 4 may be accumulated and transferred as a continuous supply electrical energy to the portable power supply 15. The regulation process may include various additional steps in other possible embodiments of the present invention. The power-management integrated circuit 43 is also electrically connected to the portable power supply 15. The power-management integrated circuit 15 in also electrically connected to the microprocessor 14. This allows the power-management integrated circuit 15 to control how the electrical energy generated by the generator 4 is distributed between the electrically operated components. The preferred embodiment of the portable power supply 15 is a rechargeable lithium ion battery that is well suited for powering a small portable computing device 1. Alternately, the portable power supply 15 may use batteries having various other chemistries such as nickel-metal-hydride or lead-acid. The portable power supply 15 may also comprise solar power.

Also referring FIG. 5, the portable computing device 1 of the present invention further comprises a wireless communication module 16. The wireless communication module 16 allows the portable computing device 1 to access public or private networks. The wireless communication module 16 is enclosed within the housing 12. The wireless communication module 16 is also electronically connected to the microprocessor 14. A wireless local access area network (WLAN) permits the wireless communication module 16 to enable short range communication between the microprocessor 14 and another external computing device. Various types of data can be exchanged between the external computing device and the microprocessor 14 via WLAN. Internet connectivity is enabled through a wide area network (WAN). WAN permits the wireless communication module 16 to send and receive data to and from remotely located computing devices. The wireless communication module 16 is electrically connected to the portable power supply 15.

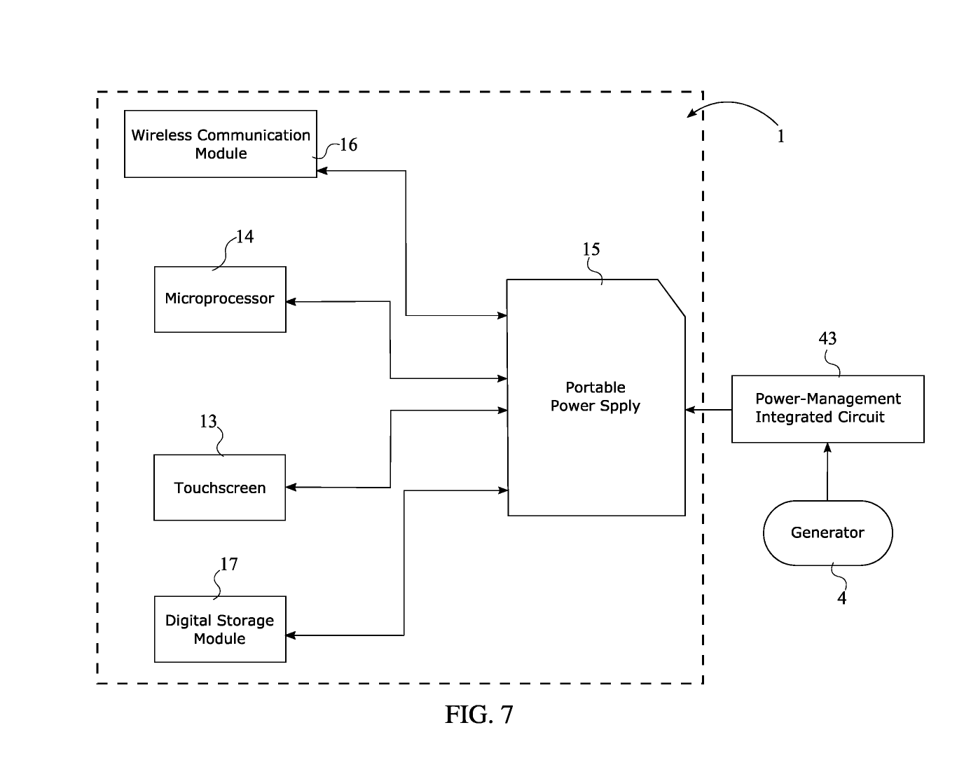

In reference to FIG. 7, the portable computing device 1 of the present invention further comprises a digital storage module 17. The digital storage module 17 stores various types data that can be accessed by the microprocessor 14. Various types of media such as images, videos, software applications, system software, and/or the like is stored in the digital storage module 17. As such, the digital storage module 17 is mounted within the housing 12 and is electronically connected to the microprocessor 14.

Although the invention has been explained in relation to its preferred embodiment, it is to be understood that many other possible modifications and variations can be made without departing from the spirit and scope of the invention as hereinafter claimed.

What is claimed is:

1. A kinetically-powered wrist-worn electronic device comprises:
a portable computing device;
a wrist strap;
a weight;
a generator;
the portable computing device comprises a housing, a touchscreen, a microprocessor, and a portable power supply;
the generator comprises a rotor and a stator;
the wrist strap being externally mounted onto the housing;
the touchscreen being mounted into the housing;
the microprocessor being mounted within the housing;
the microprocessor being electronically connected to the touchscreen;
the weight being oscillatably mounted within the housing;
the weight being torsionally connected to the rotor;
the stator being electrically connected to the portable power supply; and
the portable power supply being electrically connected to the microprocessor and the touchscreen.

2. The kinetically-powered wrist-worn electronic device as claimed in claim 1 comprises:
the weight comprises a swinging mass and a sun gear;
the swinging mass being swivelably mounted within the housing about a rotation axis;
the sun gear being coaxially positioned with the rotation axis;
the sun gear being torsionally connected to the swinging mass; and
the sun gear being engaged to the rotor.

3. The kinetically-powered wrist-worn electronic device as claimed in claim 2 comprises:
the swinging mass comprises a peripheral portion and a central portion; and
the peripheral portion and the central portion being positioned offset from each other along the rotation axis.

4. The kinetically-powered wrist-worn electronic device as claimed in claim 2, wherein the swinging mass is a semicircular profile.

5. The kinetically-powered wrist-worn electronic device as claimed in claim 1 comprises:
the rotor comprises a planet gear and a magnet;
the stator comprises a plurality of induction coils;
the planet gear being engaged to a sun gear of the weight the magnet being coaxially connected to the planet gear;
the plurality of induction coils being mounted within the housing;
the plurality of induction coils being in electromagnetic communication with the magnet; and
the plurality of induction coils being electrically connected to the portable power supply.

6. The kinetically-powered wrist-worn electronic device as claimed in claim 5 comprises:
wherein the stator comprises a flat core; and
the plurality of induction coils being wrapped around the flat core.

7. The kinetically-powered wrist-worn electronic device as claimed in claim 1 comprises:
a power-management integrated circuit;
the power-management integrated circuit being electrically connected to the generator; and
the power-management integrated circuit being electrically connected to the portable power supply.

8. The kinetically-powered wrist-worn electronic device as claimed in claim 7 comprises:
the power-management integrated circuit being electronically connected to the microprocessor.

9. The kinetically-powered wrist-worn electronic device as claimed in claim 1, wherein the portable power source is a rechargeable battery.

10. The kinetically-powered wrist-worn electronic device as claimed in claim 1 comprises:
the portable computing device further comprises a wireless communication module;
the wireless communication module being mounted within the housing;
the wireless communication module being electronically connected to the microprocessor; and
the wireless communication module being electrically connected to the portable power supply.

11. The kinetically-powered wrist-worn electronic device as claimed in claim 1 comprises:
the portable computing device further comprises a digital storage module;
the digital storage module being mounted within the housing; and
the digital storage module being electronically connected to the microprocessor.

12. A kinetically-powered wrist-worn electronic device comprises:
a portable computing device;
a wrist strap;
a weight;
a generator;
the portable computing device comprises a housing, a touchscreen, a microprocessor, and a portable power supply;
the generator comprises a rotor and a stator;
the weight comprises a swinging mass and a sun gear;
the wrist strap being externally mounted onto the housing;
the touchscreen being mounted into the housing;
the microprocessor being mounted within the housing;
the microprocessor being electronically connected to the touchscreen;
the weight being oscillatably mounted within the housing;
the weight being torsionally connected to the rotor;
the stator being electrically connected to the portable power supply;
the portable power supply being electrically connected to the microprocessor and the touchscreen;
the swinging mass being swivelably mounted within the housing about a rotation axis;
the sun gear being coaxially positioned with the rotation axis;
the sun gear being torsionally connected to the swinging mass; and
the sun gear being engaged to the rotor.

13. The kinetically-powered wrist-worn electronic device as claimed in claim 12 comprises:
the swinging mass comprises a peripheral portion and a central portion; and
the peripheral portion and the central portion being positioned offset from each other along the rotation axis.

14. The kinetically-powered wrist-worn electronic device as claimed in claim 12 comprises:
the rotor comprises a planet gear and a magnet;
the stator comprises a plurality of induction coils;
the planet gear being engaged to a sun gear of the weight;
the magnet being coaxially connected to the planet gear;
the plurality of induction coils being mounted within the housing;
the plurality of induction coils being in electromagnetic communication with the magnet; and
the plurality of induction coils being electrically connected to the portable power supply.

15. The kinetically-powered wrist-worn electronic device as claimed in claim 14 comprises:
wherein the stator comprises a flat core; and
the plurality of induction coils being wrapped around the flat core.

16. The kinetically-powered wrist-worn electronic device as claimed in claim 12 comprises:
a power-management integrated circuit;
the power-management integrated circuit being electrically connected to the generator; and
the power-management integrated circuit being electrically connected to the portable power supply.

17. The kinetically-powered wrist-worn electronic device as claimed in claim 16 comprises:
the power-management integrated circuit being electronically connected to the microprocessor;

18. The kinetically-powered wrist-worn electronic device as claimed in claim 12, wherein the portable power source is a rechargeable battery.

19. The kinetically-powered wrist-worn electronic device as claimed in claim 12 comprises:
the portable computing device further comprises a wireless communication module;
the wireless communication module being mounted within the housing;
the wireless communication module being electronically connected to the microprocessor; and
the wireless communication module being electrically connected to the portable power supply.

20. The kinetically-powered wrist-worn electronic device as claimed in claim 12 comprises:
the portable computing device further comprises a digital storage module;
the digital storage module being mounted within the housing; and
the digital storage module being electronically connected to the microprocessor.
